(19) United States
(12) Patent Application Publication
(10) Pub. No.: US 2024/0111840 A1
(43) Pub. Date: Apr. 4, 2024

(54) Selecting a Tiling Scheme for Processing Instances of Input Data Through a Neural Netwok

(71) Applicants: Advanced Micro Devices, Inc., Santa Clara, CA (US); ATI Technologies ULC, Markham (CA)

(72) Inventors: Akila Subramaniam, Allen, TX (US); Ying Liu, Mississauga (CA); Tung Chuen Kwong, Richmond Hill (CA); Juanjo Noguera, Santa Clara, CA (US)

(21) Appl. No.: 17/957,508

(22) Filed: Sep. 30, 2022

(51) Int. Cl. G06K 9/62; G06N 3/04

(52) U.S. Cl. CPC G06K 9/6227; G06K 9/6261; G06N 3/04

(57) ABSTRACT

An electronic device uses a tiling scheme selected from among a set of tiling schemes for processing instances of input data through a neural network. Each of the tiling schemes is associated with a different arrangement of portions into which instances of input data are divided for processing in the neural network. In operation, processing circuitry in the electronic device acquires information about a neural network and properties of the processing circuitry. The processing circuitry then selects a given tiling scheme from among a set of tiling schemes based on the information. The processing circuitry next processes instances of input data in the neural network using the given tiling scheme. Processing each instance of input data in the neural network includes dividing the instance of input data into portions based on the given tiling scheme, separately processing each of the portions in the neural network, and combining the respective outputs to generate an output for the instance of input data.

### BACKGROUND

### Related Art

Some electronic devices perform operations for artificial neural networks, or, more simply, neural networks. Generally, a neural network is a computational structure that includes internal elements having similarities to biological neural networks, such as those in a living creature's brain. Neural networks can be trained to perform specified tasks by using known instances of training data to configure the internal elements of the neural network to perform the specified task on unknown instances of input data. For example, neural networks can be used for tasks such as identifying whether (or not) an image includes specified image elements (e.g., faces, vehicles, etc.). As another example, neural networks can be used for upscaling image or video resolution for operations such as improving the appearance of digital video files or video games (e.g., converting lower-resolution frames of a video game to a higher resolution, etc.).

Designers have proposed numerous different types of neural network, each network including a respective arrangement of internal elements. For example, one type of neural network is a multilayer perceptron, or “fully connected,” neural network. In one common configuration, a fully connected neural network includes a set of nodes having input nodes, intermediate (or “hidden”) nodes, and output nodes arranged in a series of layers. An instance of input data is fed into the input nodes, which generate output values based on the instance of input data. The input nodes then forward the output values to intermediate nodes in a first layer of the neural network (i.e., in a first layer of hidden nodes). The nodes in the first layer weight the output values using respective weights to generate weighted input values and use the weighted input values as inputs to activation functions that generate respective outputs for the nodes in the first layer. The nodes in the first layer forward the outputs to nodes in a next layer of the neural network where similar operations are performed. In this way, values flow through the fully connected neural network, with values being generated by nodes in each layer of the neural network and forwarded to nodes in a next layer of the neural network until reaching the output nodes. The output nodes generate output(s) from the neural network. Another type of neural network is a convolutional neural network. In one common configuration, a convolutional neural network includes a set of feature processing elements that process features in instances of input data to generate input data for a fully connected neural network that is included in the convolutional neural network. The feature processing elements in some convolutional neural networks include internal elements for operations such as convolution, normalizing, and pooling. For example, in some convolutional neural networks, in the convolution internal elements, a set of filters are used to generate feature maps from instances of input data. The feature maps are then normalized in the normalizing internal elements and further processed (e.g., subsampled, downsampled, etc.) in the pooling internal elements to generate reduced-dimension feature maps that are forwarded to the fully connected neural network for processing therein. In addition to fully connected neural networks and convolutional neural networks, there are many other types of neural networks, such as auto encoders, Markov chains, belief networks, and residual networks, with each different type of neural network having a respective arrangement of internal elements.

Many modern neural networks include large numbers of internal elements. For example, fully connected neural networks can have thousands or millions of nodes arranged in numerous layers. Because neural networks include so many internal elements, computing values for the neural networks involves large numbers of computations and corresponding memory accesses (i.e., reads of data from memory and storing data to memory). For example, computing outputs of activation functions for thousands or millions of hidden nodes in a fully connected neural network can involve one or more orders of magnitude more computations. Each of these computations is associated with respective memory accesses, e.g., for acquiring weight values, storing the result values, etc. Because memory accesses are relatively slow compared to computational operations, processing instances of input data through neural networks has been memory access bound, i.e., limited in speed by the need for acquiring data from memory. This is particularly true where data cannot be acquired from a local memory for computational hardware and instead must be acquired from system/main memory (or other remote memory, such as memories in other nodes of a non-uniform memory access (NUMA) electronic device). In some cases, the computational and memory access issues have limited the size of neural networks that designers are able to use.

In an effort to enable the use of larger neural networks, designers have proposed optimizations and improvements to the neural networks themselves, as well as to the computational hardware used for processing instances of input data through the neural networks. For example, designers have scaled processing or compute units used for processing instances of input data through the neural networks, reduced the precision of computational values, reduced computations based on sparsity of data in neural networks (i.e., zeros or other values output from hidden nodes, etc.), and made many other improvements. Despite these improvements, accesses of memory still function as a bottleneck for processing instances of input data through the neural networks due to the inability to keep computational hardware supplied with data acquired from memory. Adding local memory (e.g., graphics processing unit (GPU) memory in a system in which GPUs are used as computational elements), although faster to access, is expensive and does not scale well with neural network size and other parameters. This forces the data accesses to a system/main or other remote memory, where accesses are not only slower, but are subject to competition from other processes (e.g., other video game processes for a frame-resolution upscaling neural network).

### BRIEF DESCRIPTION OF THE FIGURES

FIG. 1 presents a block diagram illustrating a fully connected neural network in accordance with some embodiments.

FIG. 2 presents a block diagram illustrating a convolutional neural network in accordance with some embodiments.

FIG. 3 presents a block diagram illustrating an electronic device in accordance with some embodiments.

FIG. 4 presents a block diagram illustrating elements used in selecting a tiling scheme in accordance with some embodiments.

FIG. 5 presents a block diagram illustrating line buffer processing in accordance with some embodiments.

FIG. 6 presents a block diagram illustrating patches used in patch processing in accordance with some embodiments.

FIG. 7 presents a block diagram illustrating layer processing in accordance with some embodiments.

FIG. 8 presents a flowchart illustrating a process for selecting a tiling scheme in accordance with some embodiments.

FIG. 9 presents a flowchart illustrating a process for using a tiling scheme for processing instances of input data through a neural network in accordance with some embodiments.

Throughout the figures and the description, like reference numerals refer to the same figure elements.

### DETAILED DESCRIPTION

The following description is presented to enable any person skilled in the art to make and use the described embodiments and is provided in the context of a particular application and its requirements. Various modifications to the described embodiments will be readily apparent to those skilled in the art, and the general principles described herein may be applied to other embodiments and applications. Thus, the described embodiments are not limited to the embodiments shown, but are to be accorded the widest scope consistent with the principles and features described herein.

### Terminology

In the following description, various terms are used for describing embodiments. The following is a simplified and general description of some of the terms. Note that these terms may have significant additional aspects that are not recited herein for clarity and brevity and thus the description is not intended to limit these terms.

Functional block: functional block refers to a set of interrelated circuitry such as integrated circuit circuitry, discrete circuitry, etc. The circuitry is “interrelated” in that circuit elements in the circuitry share at least one property. For example, the circuitry may be included in, fabricated on, or otherwise coupled to a particular integrated circuit chip, substrate, circuit board, or part thereof, may be involved in the performance of specified operations (e.g., computational operations, control operations, memory operations, etc.), may be controlled by a common control element and/or a common clock, etc. The circuitry in a functional block can have any number of circuit elements, from a single circuit element (e.g., a single integrated circuit logic gate or discrete circuit element) to millions or billions of circuit elements (e.g., an integrated circuit memory). In some embodiments, functional blocks perform operations “in hardware,” using circuitry that performs the operations without executing program code.

Data: data as used herein is a generic term that indicates information that can be stored in memories (e.g., a main memory, a cache memory, etc.) and/or used in computational, control, and/or other operations. Data includes information such as actual data (e.g., results of computational or control operations, outputs of processing circuitry, inputs for computational or control operations, variable values, sensor values, etc.), files, program code instructions, control values, variables, metadata, and/or other information.

Memory accesses: memory accesses, or, more simply, accesses, include interactions that can be performed for, on, using, and/or with data stored in memory. For example, accesses can include writes or stores of data to memory, reads of data in memory, invalidations or deletions of data in memory, moves of data in memory, writes or reads of metadata associated with data in memory, etc. In some cases, accesses of data in memories are or include accesses of metadata (i.e., reads, writes, checks, deletions, etc.) associated with the data, such as validity information, coherence information, permissions information, etc.

### Neural Networks

In the described embodiments, an electronic device performs operations for, and associated with, neural networks. A neural network is a computational structure that includes internal elements having similarities to biological neural networks, such as those in a living creature's brain. Neural networks can be trained to perform specified tasks by using known instances of training data to configure the internal elements of the neural network to perform the specified task on unknown instances of input data. For example, neural networks can be used for tasks such as identifying whether (or not) an image includes specified image elements (e.g., faces, vehicles, etc.). As another example, neural networks can be used for upscaling image or video resolution for operations such as improving the appearance of digital video files or video games (e.g., converting lower-resolution frames of a video game to a higher resolution, etc.).

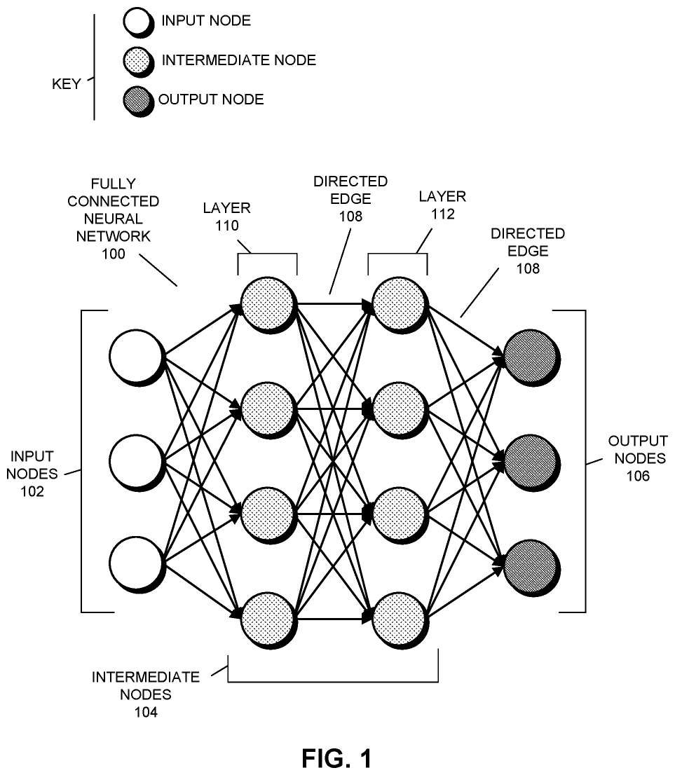

One type of neural network is a “fully connected” neural network. Fully connected neural networks include, in their internal elements, a set of artificial neurons, or “nodes,” that are interconnected with one another. In some embodiments, a fully connected neural network can be visualized as a form of weighted graph structure in which the nodes include input nodes, intermediate (or “hidden”) nodes, and output nodes. FIG. 1 presents a block diagram illustrating a fully connected neural network 100 in accordance with some embodiments. Fully connected neural network 100 includes input nodes 102, intermediate nodes 104 in layers 110 and 112, output nodes 106, and directed edges 108 (only two directed edges and layers are labeled for clarity). Within the fully connected neural network, each node other than output nodes 106 is connected to one or more downstream nodes via a directed edge that has an associated weight. During operation, input nodes 102 in a first layer of fully connected neural network 100 receive inputs from an external source and process the inputs to produce input values. Input nodes 102 forward the input values to intermediate nodes 104 in the next layer 110 of fully connected neural network 100. The receiving intermediate nodes 104 weight the received inputs based on a weight of a corresponding directed edge, i.e., adjust the received inputs such as multiplying by a weighting value, etc. Each intermediate node 104 sums the corresponding weighted received inputs and possibly a bias value to generate an internal value and evaluates an activation function for that intermediate node 104 using the internal value to produce a result value. Intermediate nodes 104 then forward the result values as input values to intermediate nodes 104 in the next layer 112 of fully connected neural network 100, where the input values are used to generate internal values and evaluate an activation function as described above. In this way, values flow through intermediate nodes 104 in layers of fully connected neural network 100 until a last layer of intermediate nodes 104 forward result values to output nodes 106 for fully connected neural network 100, which generate outputs for fully connected neural network 100. Continuing the example above, the outputs produced by output nodes 106—and thus from fully connected neural network 100—can be in a form, e.g., a number between 0-1, that indicates whether or not an image is likely to include (or not) the specified image element. Alternatively, the outputs produced by output nodes 106 can be other values, e.g., pixel values in an image or portion thereof generated by fully-connected neural network 100, etc.

As described above, values forwarded along directed edges between nodes in a fully connected neural network (e.g., fully connected neural network 100) are weighted using a weight associated with each directed edge. By setting the weights associated with the directed edges during a training process so that desired outputs are generated by the fully connected neural network, the fully connected neural network can be trained to produce intended outputs such as identifying image elements in images or generating upscaled images. When training a fully connected neural network, numerous instances of training data having expected outputs are processed in the fully connected neural network to produce actual outputs from the output nodes. Continuing the example above, the instances of training data would include digital images that are known to include (or not) particular image elements, and thus for which the fully connected neural network is expected to produce outputs that indicate that the image element is likely present (or not) in the images. After each instance of training data is processed in the fully connected neural network to produce an actual output, an error value, or “loss,” between the actual output and a corresponding expected output is calculated using mean squared error, log loss, or another algorithm. The loss is then worked backward through the fully connected neural network, or “backpropagated” through the fully connected neural network, and used to adjust the weights associated with the directed edges in the fully connected neural network in order to reduce the error for the instance of training data. The backpropagation operation adjusts the fully connected neural network's response for that particular instance of training data and subsequent instances of input data. For example, one backpropagation technique, which can be called gradient descent, involves computing a gradient of the loss with respect to the weight for each directed edge in the fully connected neural network. Each gradient is then multiplied by a training coefficient or “learning rate” to compute a weight adjustment value. The weight adjustment value is next used in calculating an updated value for the corresponding weight, e.g., added to an existing value for the corresponding weight.

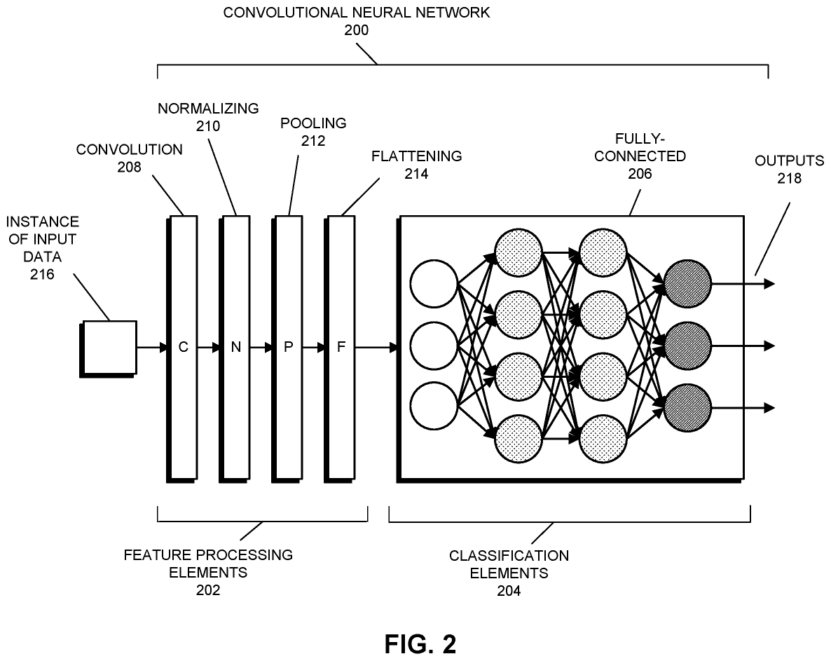

Another type of neural network is a “convolutional” neural network. FIG. 2 presents a block diagram illustrating a convolutional neural network 200 in accordance with some embodiments. As can be seen in FIG. 2, the internal elements of convolutional neural network 200 can be grouped into feature processing elements 202 and classification elements 204. Feature processing elements 202 process features in instances of input data 216 (e.g., digital images, digital audio recordings, images to be upscaled, etc.) in preparation for processing the instances of input data—or, rather, the instances of input data after the feature processing—in classification elements 204. Feature processing elements 202 include internal elements, or “layers,” for convolution, normalizing, and pooling. In the convolution 208 internal elements/layer, a set of filters are used to generate feature maps from instances of input data. The feature maps are then normalized (e.g., using rectified linear units) in the normalizing 210 internal elements/layer. After normalization, the pooling 212 internal elements/layer to generate reduced-dimension feature maps (e.g., via subsampling, downsampling, etc.). Flattening 214 internal elements/layer next prepare the reduced-dimension feature maps from the pooling 212 internal elements/layer for input into the fully connected 206 internal elements. Classification elements 204 include a fully connected 206 neural network (similar to the fully-connected neural network described above) that classifies inputs (i.e., flattened reduced-dimension feature maps) as including specified elements (or not) and produces outputs 218 representing the classification. As with the fully connected neural network, backpropagation (i.e., gradient descent, etc.) can be used to train the convolution 208 internal elements/layers by adjusting values in the set of filters and other values in the internal elements/layers of feature processing elements 202.

Although examples of neural networks are presented in FIGS. 1-2, in some embodiments, a different arrangement of nodes and/or layers is present in a given neural network. For example, a fully connected neural networks—including those found within convolutional neural networks—can have thousands or millions of nodes arranged in numerous layers. In addition, the feature processing elements for convolutional neural networks may have multiple/repeated layers of convolution, normalizing, pooling, and/or other internal elements. The examples in FIGS. 1-2 are also generic; fully connected and/or convolutional neural networks may include different arrangements of internal elements and/or internal elements that are not shown in FIGS. 1-2. Also, although fully connected and convolutional neural networks are presented as examples, in some embodiments, different type(s) of neural network(s) are used. Generally, the described embodiments are operable with any configuration of neural network(s) that can perform the operations herein described and/or upon which the operations herein described can be performed.

### Overview

In the described embodiments, an electronic device includes processing circuitry that performs operations for and associated with processing instances of input data through neural networks. For example, in some embodiments, the neural network is a convolutional neural network that upscales digital images, i.e., increases a video resolution of the digital images (e.g., frames of a video game, frames of a video file, etc.). In these embodiments, the instances of input data are the digital images and a result of processing an instance of input data in the neural network is a digital image with increased resolution. In the described embodiments, the processing circuitry can use a tiling scheme for processing instances of input data through a neural network. A tiling scheme is a scheme for dividing instances of input data into multiple portions to be processed in the neural network. Once an instance of input data has been divided into portions, the portions—one at a time or in specified groups—are processed in the neural network to generate a respective result. The processing circuitry then combines the respective results to generate an overall output for that instance of input data.

In some embodiments, the processing circuitry supports a set of tiling schemes that includes two or more different tiling schemes. In these embodiments, each of the tiling schemes is associated with a different arrangement of portions into which instances of instance of input data are divided for processing through neural networks. For example, in some embodiments, the tiling schemes include a line buffer processing tiling scheme. In these embodiments, the portions of the instances of input data are individual lines from among a plurality of lines in the instances of input data (e.g., horizontal lines of one or more pixels in height in a digital image) and line buffer processing is used for processing specified groups of lines from instances of input data in the neural network. As another example, in some embodiments, the tiling schemes include a patch processing tiling scheme. In these embodiments, the portions of the instances of input data are patches from among a plurality of patches in the instances of input data (e.g., regions in a digital image) and patches from the instances of input data are processed in the neural network. As yet another example, in some embodiments, the tiling schemes include a layer processing tiling scheme. In these embodiments, the portions of the instances of input data are channels or other divisions from among a plurality of channels in the instances of input data and sets of channels from the instances of input data are processed in the neural network. That is, multiple channels are fused in convolutional layers or other layers of the neural network and processed as a group.

In some embodiments, the processing circuitry selects a tiling scheme from among the set of tiling schemes to be used for processing instances of input data through neural networks. In these embodiments, in other words, the processing circuitry determines a tiling scheme from among the set of tiling schemes that is to be used for processing instances of input data. For this operation, the processing circuitry first acquires, generates, or retrieves information about the neural network and the processing circuitry. For example, in some embodiments, the information about the neural network includes characteristics of the neural network and/or the instances of input data and the information about the processing circuitry includes properties of the processing circuitry. The processing circuitry then uses the information about the neural network and the processing circuitry to select a tiling scheme from among the set of tiling schemes. For example, the processing circuitry can select the tiling scheme using a set of tiling scheme rules that identify tiling scheme(s) to be used for specified combinations of neural network characteristics and processing circuitry properties. In some embodiments, the processing circuitry dynamically selects a tiling scheme, such as by selecting a tiling scheme just before beginning to process instances of input data through a neural network.

In some embodiments, after selecting a given tiling scheme to be used for processing instances of input data, the processing circuitry processes one or more instances of input data using the given tiling scheme. For this operation, when processing each instance of input data, the processing circuitry divides that instance of input data into multiple portions based at least in part on the arrangement of portions associated with the given tiling scheme. For example, if the patch processing tiling scheme is being used, the processing circuitry can divide that instance of input data into multiple patches (each patch possibly including a bordering overlap region). The processing circuitry then separately process each of the portions for that instance of input data in the neural network to generate a respective output for that portion. Continuing the patch processing example, the processing circuitry can process each of the patches for that instance of input data to generate a respective, and partial, result associated with that patch. The processing circuitry then combines the respective outputs to generate an output from the neural network for that instance of input data. Again continuing the patch processing example, the processing circuitry can combine the respective result for each of the patches to generate the overall output for that instance of input data.

In some embodiments, using the tiling schemes is associated with overhead for configuring/preparing the portions of the instances of input data, handling the processing of the individual portions of in the neural network, and/or handling the results of processing the individual portions in the neural network. For example, and as described above, the processing circuitry can perform operations for combining results generated by processing two or more (and possibly a large number of) individual portions in the neural network to generate an overall result for an instance of input data. As another example, in some embodiments, the processing circuitry determine, for the patch processing tiling scheme, some or all of: a size and/or shape of the patches and an overlap of each patch with neighboring patches (for avoiding artifacts in an overall result, etc.).

By using the tiling schemes for processing instances of input data, the described embodiments can divide the computational workload for processing instances of input data among multiple portions. This can mean that, in contrast to processing undivided/whole instances of input data, instances of input data can be processed more efficiently by the processing circuitry (i.e., without undue delays due to overloaded processing circuitry, etc.). In addition, the processing circuitry may be able to store much, if not all, of the data associated with processing the instances of input data in the neural network in a local memory rather than a remote memory (e.g., a remote memory that is to be accessed over a relatively slow communication route such as a main memory). This can reduce the number of longer-latency memory accesses in the remote memory that the processing circuitry would perform when processing undivided/full instances of input data without using a tiling scheme. By selecting a tiling scheme from among the set of tiling schemes based on the information about the neural network and the processing circuitry, the described embodiments better tailor the operation of the processing circuitry to the particular neural network and the instances of input data being processed therein. This can help to avoid a one-size-fits-all use of a single tiling scheme that can be inefficient for particular types of neural network and/or processing circuitry. By improving the operation of the processing circuitry while processing instances of input data through a neural network, the described embodiments can improve the overall operation of the electronic device. Improving the operation of the electronic device improves user satisfaction with the electronic device.

### Electronic Device

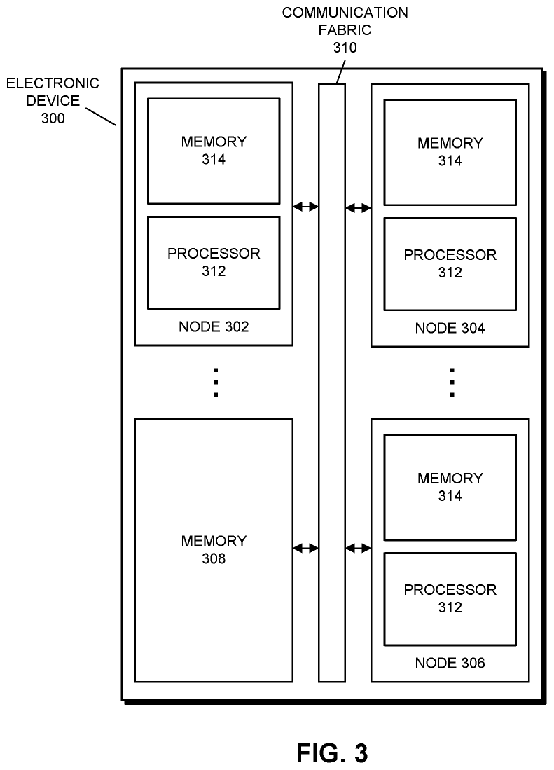

FIG. 3 presents a block diagram illustrating an electronic device 300 in accordance with some embodiments. As can be seen in FIG. 3, electronic device 300 includes a number of nodes 302-306, memory 308, and communication fabric 310. Generally, the nodes 302-306, memory 308, and communication fabric 310 are implemented in hardware, i.e., using corresponding integrated circuitry, discrete circuitry, and/or devices. For example, in some embodiments, the nodes 302-306, memory 308, and communication fabric 310 are implemented in integrated circuitry on one or more semiconductor chips, are implemented in a combination of integrated circuitry on one or more semiconductor chips in combination with discrete circuitry and/or devices, or are implemented in discrete circuitry and/or devices. In some embodiments, some or all of nodes 302-306, memory 308, and/or communication fabric 310 perform operations for, or associated with, selecting a tiling scheme to be used for processing instances of input data through a neural network and/or using the tiling scheme for processing instances of input data in the neural network as described herein.

Nodes 302-306 are separate computational resources that include hardware for performing computational, control, memory access, and/or other operations. For example, in some embodiments, nodes 302-306 are graphics processing units (GPUs) or GPU cores, each having a local GPU memory (i.e., memory 308). As another example, in some embodiments, node 302 is a central processing unit (CPU) or CPU core and nodes 304-306 are GPUs or GPU cores—and thus electronic device 300 includes a mixture of a CPU and GPUs. As yet another example, in some embodiments, at least one of nodes 302-306 is or includes a neural network accelerator, i.e., a functional block that is arranged to dynamically process neural network data and/or neural network internal elements to improve the performance of processing instances of input data through a neural network. For example, in some embodiments, processor 312 in node 302 includes a number of CPU and/or GPU cores along with a neural network accelerator.

Each of nodes 302-306 includes a processor 312, which is a functional block that performs computational, memory access, control, and/or other operations. For example, each processor 312 can be or include one or more CPUs or CPU cores, GPUs or GPU cores, accelerated processing units (APUs), system on a chips (SOCs), field programmable gate arrays (FPGAs), and/or other functional blocks. In other words, each processor 312 includes processing circuitry, i.e., circuit elements such as integrated circuitry and/or discrete circuitry, that perform the computational, memory access, control, and/or other operations. In some embodiments, the processor 312 in some or all of nodes 302-306 includes different processing circuitry than other nodes. For example, in some embodiments, the processor 312 in node 302 is a CPU, while the processor 312 in other nodes 304-306 is a GPU, an FPGA, and/or another type of processor.

In some embodiments, the “processing circuitry” described herein includes some or all of the processors 312 in nodes 302-306. For example, in some embodiments, the processor 312 (i.e., processing circuitry) in one or more of nodes 302-306 performs operations for selecting a tiling scheme to be used for processing instances of input data through a neural network. In addition, the processor 312 (i.e., processing circuitry) in one or more of nodes 302-306 performs operations for using the tiling scheme for processing instances of input data in the neural network. In some embodiments, different portions of the processing circuitry—and thus processors 312 in different nodes—perform operations for selecting the tiling scheme and for using the tiling scheme for processing the instances of input data in the neural network.

Each of nodes 302-306 includes a memory 314, which is a functional block that performs operations for or associated with storing data for accesses by the processor 312 in that node—and possibly by processors 312 in other nodes. Each memory 314 includes volatile and/or non-volatile memory circuits for storing data, as well as control circuits for handling accesses of the data stored in the memory circuits, performing control or configuration operations, etc. For example, in some embodiments, the processor 312 in some or all of nodes 302-306 includes one or more GPU cores and the respective memory 314 includes graphics memory circuitry such as graphics double data rate synchronous DRAM (GDDR).

Memory 308 is a functional block that stores data for accesses by other functional blocks in electronic device 300. Memory 308 includes memory circuitry such as fifth generation double data rate synchronous dynamic random-access memory (DDRS SDRAM) and/or other types of memory circuitry, as well as control circuitry for handling accesses of the data stored in the memory circuitry.

In some embodiments, memory 308 is what has traditionally been regarded as a “main” or “system” memory in electronic device 300 and the memory 314 in each of the nodes is a “local” memory for that node. The processor 312 in each node can typically more rapidly access data in the local memory 314 in that node than in memory 308—and memory 308 is therefore regarded as a “remote” memory for each of the processors. In some embodiments, e.g., non-uniform memory access (NUMA) embodiments, processors 312 can access data in memories 314 in other nodes. For example, in some embodiments, processor 312 in node 302 can access data in one or both of the local memories 314 in nodes 304-306. In these embodiments, a processor can typically more rapidly access data in the local memory 314 in its own node than in a memory 314 in another node and the memory 314 other nodes is/are therefore also regarded as a “remote” memory for each of the processors. In these embodiments, hence, any memory access by a processor of a memory other than the local memory 314 for a node is considered a remote memory access.

Communication fabric 310 is a functional block that performs operations for or associated with communicating data between other functional blocks in electronic device 300 (e.g., nodes 302-306 and memory 308). Communication fabric 310 is or includes wires, guides, traces, wireless communication channels, transceivers, control circuitry, antennas, and/or other functional blocks and devices that are used for communicating data. For example, in some embodiments, electronic device 300 is or includes a circuit board or other interposer to which nodes 302-306 are mounted or connected and communication fabric 310 is an inter-node communication route. As another example, in some embodiments, electronic device 300 is or includes a set or group of computers (e.g., a group of server nodes in a data center) and communication fabric 310 is a wired and/or wireless network that connects the nodes 302. As yet another example, in some embodiments, electronic device 300 is included on one or more semiconductor chips and fabric 310 is an on-die interface or interconnect. In some embodiments, a benefit of using a tiling scheme as described herein is reduced traffic on communication fabric 310 between nodes that are processing instances of input data through a neural network and memory 308, because data for processing the instances of input data (e.g., computational inputs, intermediate values, results, etc.) can be partially or wholly stored in a local memory 314 in the respective node.

Although electronic device 300 is shown in FIG. 3 with a particular number and arrangement of functional blocks and devices, in some embodiments, electronic device 300 includes different numbers and/or arrangements of functional blocks and devices. For example, in some embodiments, electronic device 300 includes a different number of nodes. In addition, although each of nodes 302-306 is shown with a particular arrangement of functional blocks, in some embodiments, some or all of nodes 302-306 include a different number and/or arrangement of functional blocks. Generally, electronic device 300 and nodes 302-306 include sufficient numbers and/or arrangements of functional blocks to perform the operations herein described.

Electronic device 300 and nodes 302-306 are simplified for illustrative purposes. In some embodiments, however, electronic device 300 and/or nodes 302-306 include additional or different functional blocks, subsystems, elements, and/or communication paths. For example, electronic device 300 and/or nodes 302-306 may include display subsystems, power subsystems, input-output (I/O) subsystems, etc. Electronic device 300 and nodes 302-306 generally include sufficient functional blocks, subsystems, elements, and/or communication paths to perform the operations herein described.

Electronic device 300 can be, or can be included in, any device that can perform the operations described herein. For example, electronic device 300 can be, or can be included in, a desktop computer, a laptop computer, a wearable computing device, a tablet computer, a piece of virtual or augmented reality equipment, a smart phone, an artificial intelligence (AI) or machine learning device, a server, a network appliance, a toy, a piece of audio-visual equipment, a home appliance, a vehicle, and/or combinations thereof.

### Tiling Schemes

Recall that processing instances of input data in the neural network is associated with large computational loads and memory system bandwidth demands. In other words, processing a given instance of input data through a neural network, requires a large number of computations for computing neural network data (e.g., convolutional layer outputs, weighted input values for nodes, activation function results, output values, etc.) as well as a large number of memory accesses for accessing the neural network data and other data used for the neural network (e.g., convolutional filters, weight values, etc.). In order to avoid the need for performing all of the computations and memory accesses associated with processing a given instance of input data in the neural network at once, the described embodiments can divide the given instance of input data into portions and process the portions separately (i.e. one at a time or in specified groups). A respective result from processing each of the portions in the neural network can then be combined into a full result for the given instance of input data. The division of instances of input data into portions is called “tiling” and schemes for dividing the instances of input data into portions are collectively called “tiling schemes” in this description. Although using a tiling scheme adds overhead associated with the tiling scheme itself and/or separately processing portions of instances of input data in the neural network, using an appropriate tiling scheme means that a reduced number of computations can be performed for processing each portion of a given instance of input data (i.e., in comparison to the number of computations performed for processing the entire instance of input data). The computations can therefore be performed using less or less powerful computational hardware without undue delay or otherwise overloading the computational hardware. In addition, each portion of a given instance of input data is associated with less data (i.e., a smaller number of values) that must be accessed in the memory in comparison to the data that must be accessed for processing the entire instance of input data. Much, if not all, of the data can therefore be accessed in a local memory (e.g., memory 314) rather than a remote memory (e.g., memory 308).

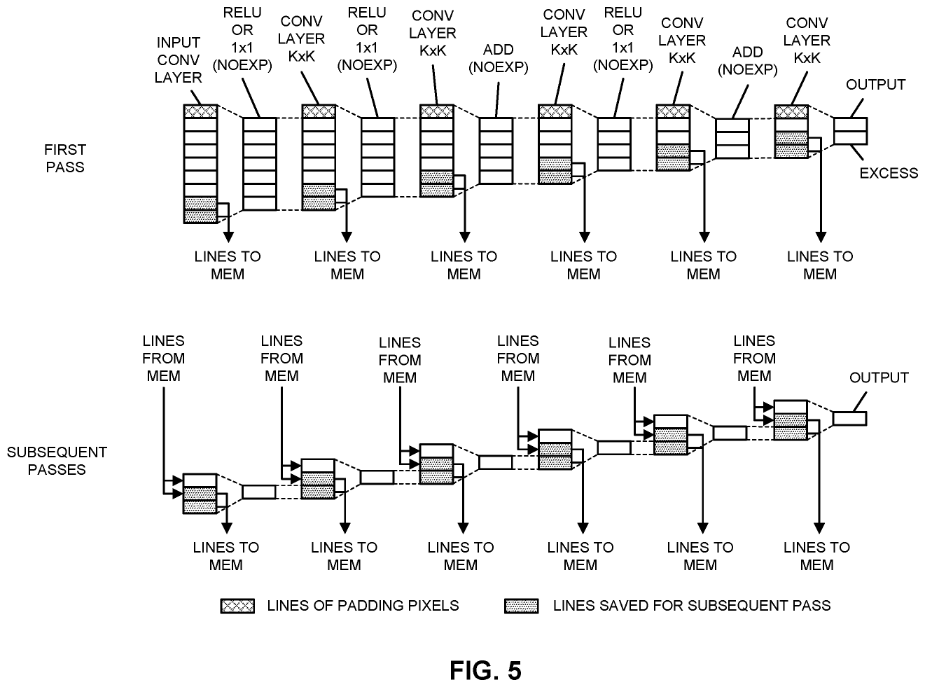

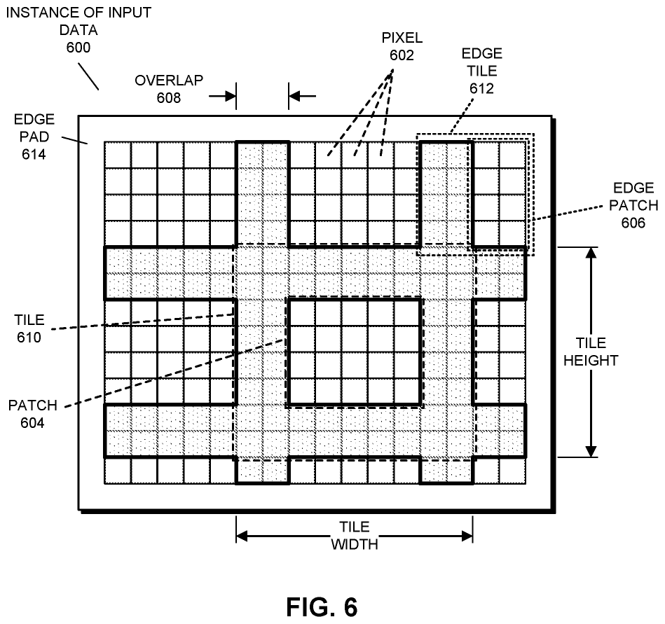

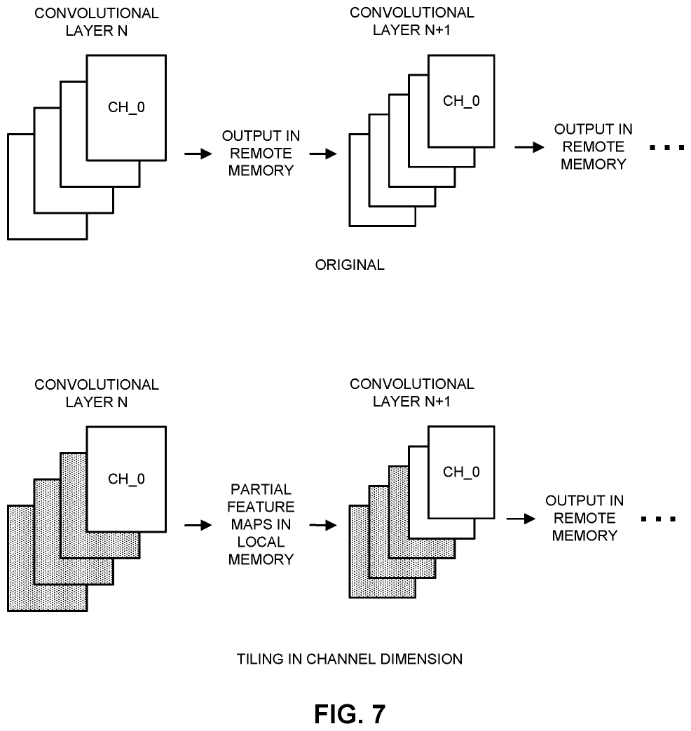

In some embodiments, multiple tiling schemes are supported by processing circuitry. In these embodiments, each of the tiling schemes is associated with a different arrangement of portions into which instances of input data are divided for processing in the neural network. In some embodiments, a first tiling scheme is a line buffer processing tiling scheme. The line buffer processing tiling scheme involves processing groups/subsets of input lines from instances of input data to generate respective output lines of data. The individual output lines of data are combined to generate the output result. A line buffer processing tiling scheme is described in more detail with respect to FIG. 5. In some embodiments, a second of the tiling schemes is a patch processing tiling scheme. The patch processing tiling scheme involves processing patches (i.e., subsections, parts, blocks, regions, etc.) of instances of input data to generate respective output data patches to be combined with other output data patches to form the output result. A patch processing tiling scheme is described in more detail with respect to FIG. 6. In some embodiments, a third tiling scheme is a layer processing tiling scheme. The layer processing tiling scheme involves processing sets of channels of instances of input data to generate respective output data to be combined with other output data to form the output result. A layer processing tiling scheme is described in more detail with respect to FIG. 7. In some embodiments, tiling schemes other than these three tiling schemes are included in the set of tiling schemes that is supported by the processing circuitry.

In the described embodiments, processing circuitry in an electronic device performs operations for selecting a tiling scheme to be used when processing instances of input data through a neural network. For example, processing circuitry in a central processing unit, a graphics processing unit, a neural network accelerator, and/or other processing circuitry can select a given tiling scheme to be used for processing instances of input data in the neural network from among a set of available tiling schemes. In some embodiments, the processing circuitry that selects the tiling scheme also processes the instances of input data in the neural network using the tiling scheme. In some embodiments, however, processing circuitry in a first electronic device may select the tiling scheme and processing circuitry in a second, different electronic device may use the tiling scheme for processing instances of input data in the neural network. Alternatively, a first portion of processing circuitry (e.g., a neural network accelerator, a CPU, a GPU, etc.) in a given electronic device may select the tiling scheme and a second portion of processing circuitry (e.g., one or more GPUs or CPUs, etc.) may process the instances of input data in the neural network.

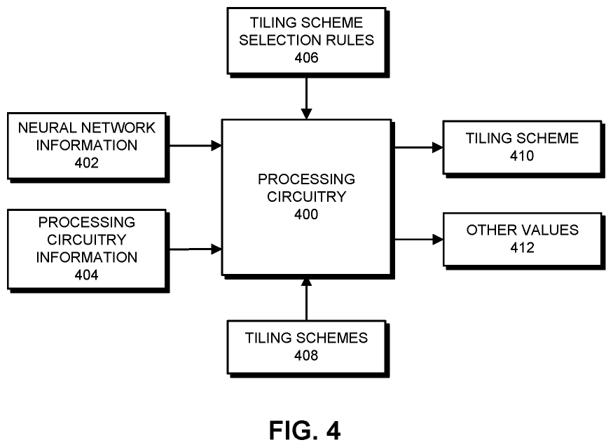

FIG. 4 presents a block diagram illustrating elements used in selecting a tiling scheme in accordance with some embodiments. Although various elements are shown in FIG. 4, in some embodiments, different elements are used or the elements are used differently. In addition, although certain operations are described for FIG. 4, in some embodiments, different operations are performed and/or the operations are performed in a different order. Generally, in the described embodiments, processing circuitry selects a tiling scheme from among a set of available tiling schemes to be used for processing instances of input data through a neural network.

For the example in FIG. 4, it is assumed that a neural network is a convolutional neural network that performs upscaling operations for digital images. The convolutional neural network therefore includes a number of convolutional layers, addition layers, rectified linear unit or 1×1 layers, and/or other layers used for image upscaling. The instances of input data that are processed in the neural network are lower resolution digital images and the overall result of the neural network are higher resolution digital images. For example, the lower resolution digital images can be 720×480 digital images such as frames from a video file or video game, individual digital images, etc., and thus can be 720 pixels wide/across by 480 pixels high, and the higher resolution digital images can be 2048×1080 pixels (sometimes called 2K) or 3840×2160 pixels (sometimes called 4K). It is further assumed that processing circuitry 400 executes a compiler and/or another software application that causes the processing circuitry to perform the operations described for FIG. 4. Generally, when executed by the processing circuitry, the compiler selects a tiling scheme as described herein and causes the processing circuitry to use the tiling scheme for processing the instances of input data in the neural network.

For the example in FIG. 4, it is further assumed that the processing circuitry includes at least one CPU core and/or GPU core that performs the operations for selecting the tiling scheme and one or more CPU cores and/or GPU cores that perform operations for processing the instance of input data in the neural network—and the selecting and processing CPU and/or GPU core(s) may be different than the processing CPU and/or GPU core(s). In some embodiments, the processing circuitry initially selects the tiling scheme and then performs some or all of the operations for processing instances of input data through the model. In other words, the processing circuitry first sets up the processing of instances of input data through the model and then takes part in operations for processing instances of input data through the model. Note that “processing circuitry” as used herein can include any type of processing circuitry, from a single application specific integrated circuit (e.g., a neural network accelerator, etc.) to complex general purpose processing circuitry such as a CPU core and/or GPU core—or combinations thereof.

As can be seen in FIG. 4, processing circuitry 400 receives—or otherwise retrieves, acquires, generates, etc.—neural network information 402. For example, processing circuitry 400 can analyze a purpose-specific characteristics file for the neural network, extract the neural network information from software files that define the neural network, and/or receive information files from other entities (e.g., users, software applications, etc.). Neural network information 402 identifies neural network characteristics such as an internal arrangement of the neural network; properties of filters used in the neural network; feature sizes for the neural network; and channel sizes for the neural network. In some embodiments, neural network information 402 includes information about properties of instances of input data to be processed in the neural network and outputs of the neural network (e.g., the resolutions of one or both of the instances of input data and output result). The information about the internal arrangement of the neural network includes information such as a number of layers of the neural network, an arrangement of layers in the neural network, operations performed on data in the neural network (e.g., downsampling, pooling, etc.), filter sizes and natures, etc. Processing circuitry 400 also receives—or otherwise retrieves, acquires, generates, etc.—processing circuitry information 404. Processing circuitry information 404 identifies properties of the processing circuitry such as an amount of local memory available for storing data by the processing circuitry and an amount of processing capacity of the processing circuitry (e.g., a number, type, and/or arrangement of compute units or other processing circuitry, etc.).

Along with neural network information 402 and processing circuitry information 404, processing circuitry 400 also receives—or otherwise retrieves, acquires, etc.—tiling scheme selection rules 406. Tiling scheme selection rules 406 identify tiling scheme(s) that might be used for specified combinations of neural network characteristics and processing circuitry properties. For example, in some embodiments, tiling scheme selection rules 406 include a table, database, or other record that relates possible combinations of neural network characteristics and processing circuitry properties to tiling schemes. In some embodiments, two or more tiling schemes may be associated with one or more combinations of neural network characteristics and processing circuitry properties—and tiling scheme selection rules may include tie-breaker rules that enable processing circuitry to select a given tiling scheme from among the two or more tiling schemes.

Processing circuitry 400 also receives an identification of tiling schemes 408 supported by processing circuitry 400 (and/or by other/additional processing circuitry in electronic device 300). The identification of the tiling schemes 408 includes one or more values that indicate whether (or not) a given tiling scheme is supported by processing circuitry 400 (and/or by other/additional processing circuitry in electronic device 300).

Based on neural network information 402, processing circuitry information 404, tiling scheme selection rules 406, and the identification of the tiling schemes 408, processing circuitry 400 selects a given tiling scheme 410 from among the tiling schemes. For example, processing circuitry 400 can determine the tiling schemes that are available using the identification of the tiling schemes 408 and then perform a lookup in a table in tiling scheme selection rules 406 based on neural network information 402 and processing circuitry information 404 to determine the given tiling scheme 410. In some embodiments, processing circuitry 400 makes a record of the selected tiling scheme 410 that is subsequently used by the processing circuitry 400 (or other entities) for processing the instances of input data in the neural network. In some embodiments, processing circuitry 400 also generates, acquires, or otherwise determines other values 412 to be used for the selected tiling scheme, such as patch sizes and overlaps for the patch processing tiling scheme. Processing circuitry 400 can then process instances of input data in the neural network using the given tiling scheme 410—and possibly the other values 412—as described herein.

### Line Buffer Processing Tiling Scheme

In some embodiments, a set of tiling schemes supported by processing circuitry in an electronic device includes a line buffer processing tiling scheme. Generally, for the line buffer processing tiling scheme, instances of input data are divided into multiple lines (e.g., lines of a given number of pixels in height and specified width, etc.) for processing in the neural network. The line buffer processing tiling scheme is used for neural networks (e.g., convolutional neural networks, etc.) that are used for processing digital images or other types of input data that can be divided or broken up into lines (and which may already be organized into a set of lines). For example, line buffer processing can be used for resolution upscaling, denoising, reconstruction, etc. for digital images (e.g., frames of a video game or video file, still digital images, etc.). Although line buffer processing can be more efficient than processing full instances of input data in some cases, line buffer processing may not be efficiently applied to all arrangements of neural network, instances of input data, and/or output results. For example, in some embodiments, for using line buffer processing in processing digital images, although the output results can be relatively high resolution, the neural network should be somewhat limited in size, i.e., limited to a given number of layers or less.

As described elsewhere herein, processing circuitry can select a tiling scheme from among multiple tiling schemes to be used for processing instances of input data in the neural network. The selection of a tiling scheme is generally made based on one or more tiling scheme rules. In some embodiments, the processing circuitry can select line buffer processing when: (1) the neural network has less than M layers, where M=30, 35, or another number; (2) the resolution or size of the output results are below K, where K=full high definition (e.g., 1920×1080 pixels), 2K (e.g., 2048×1080 pixels), 4K (e.g., 3840×2160 pixels), or another resolution; and (3) there is sufficient local memory for storing a specified amount (e.g., all, 80%, etc.) of data to be accessed while processing portions of instances of input data in the neural network. In some embodiments, additional rules about the characteristics of the neural network may apply, such as feature dimensions remaining unchanged across layers within the neural network (e.g., no pooling, downsampling, and/or other operations) and filters being uniformly sized, e.g., 1×1, 3×3, etc.

In some embodiments, in order to use the line buffer processing, the processing circuitry performs multiple passes using specified groups of lines acquired from a given instance of input data. In other words, the processing circuitry acquires sets of lines, i.e., the portions of the given instance of input data, to be processed in the neural network. The processing circuitry includes more lines in the first pass than subsequent passes due to the need to avoid certain issues that can occur if too few lines are processed in the first pass. FIG. 5 presents a block diagram illustrating line buffer processing in accordance with some embodiments. Although an embodiment of line buffer processing is shown in FIG. 5, in some embodiments, different arrangements of lines and/or neural network layers are used. Generally, in the described embodiments, for using line buffer processing, specified groups of lines are acquired from instances of input data and processed in the neural network to generate respective output lines, which are then combined into overall results for the instances of input data.

For the example in FIG. 5, an instance of input data is assumed to be a lower resolution digital image that is undergoing resolution upscaling to convert the digital image to a higher resolution. The digital image includes horizontal “lines” of pixels one or more pixels in height. The groups of the lines are the “portions” of the instances of input data that are processed in the neural network as described herein. That is, the groups of the lines from the lower resolution digital image are acquired (e.g., read from a memory) and processed in the neural network to generate output lines for the higher resolution digital image. The layers are labeled as convolutional layers (CONV LAYER) and rectified linear unit (RELU), 1×1, and/or addition (ADD) layers for the first pass, but are not labeled for the subsequent passes for clarity. The layers for the subsequent passes are convolutional layers or RELU, 1×1, and/or addition layers similarly to the first pass layers. For example, the first layer of the first pass is an input convolutional layer, as is the first layer for the subsequent passes, the second layer for the first pass is a RELU or 1×1 layer, as is the second layer for the subsequent passes, and so forth.

As can be seen in FIG. 5, for the first pass, a number of lines is acquired from the instance of input data and processed through convolutional layers (CONV LAYER) alternating with add or rectified linear unit (RELU) layers. In each convolutional layer, a line of padding pixels (of predefined values) is added prior to processing in the convolutional layer. The output from the convolutional layer is then processed in the subsequent addition, 1×1, and/or RELU layer. The output of the final convolutional layer is a single line of the output As shown in FIG. 5, all of the convolutional layers use the same size K×K filters, which is assumed to be 3×3 for the example, and no extra pixels (NOEXP) are permitted in the add, 1×1, and RELU layers. For the first pass, in each convolutional layer, two lines are stored in memory to be used as inputs for the similar layer in a subsequent/next pass.

For each subsequent pass, a next line is acquired from the instance of input data and processed through convolutional layers (CONV LAYER) alternating with add or rectified linear unit (RELU) layers. In each convolutional layer, the two lines that were stored in memory during a similar convolutional layer in a previous pass are added prior to processing in the convolutional layer. The output from the convolutional layer is then processed in the subsequent add, 1×1, or RELU layer. During the subsequent pass, in each convolutional layer, two lines are stored in memory to be used as inputs for the similar layer in a subsequent/next pass.

In some embodiments, the number of extra lines used in the first pass is computed as a result, i, of the following formula. If k is the filter size and n the number of convolutional layers with k>1, then i=(k−2)*n+1. This is, again, shown in FIG. 5 as i=9 input lines are used for outputting the one line of the result—and i=3 is used in the subsequent passes. In some embodiments, at each convolutional layer that has k>1, k−1 lines are saved—and because the filters are assumed to be 3×3, two lines are saved at each convolutional layer.

In some embodiments, when line processing is used for processing instances of input data in the neural network, the data that is accessed (i.e., stored in memory and read from memory) during the processing fits in the local memory. That is, the local memory has sufficient capacity for storing input values, intermediate values, results, etc. as needed. In some embodiments, the amount of memory to be accessed can be computed as a function of filter size, line width (in pixels, etc.), and the number of convolutional layers. For example, in some embodiments, the local memory that is used for accessing the data for each pass can be computed as number of channels*k−1*line width*n, where the number of channels is a property of the input image.

### Patch Processing Tiling Scheme

In some embodiments, a set of tiling schemes supported by processing circuitry in an electronic device includes a patch processing tiling scheme. Generally, for the patch processing tiling scheme, instances of input data are divided into multiple patches (i.e., regions, blocks, subsections, etc.) for processing in the neural network. The patch processing tiling scheme is for neural networks (e.g., convolutional neural networks, etc.) used for processing digital images or other types of input data that can be divided into patches (and which may already be organized into a set of patches). For example, patch processing can be used for resolution upscaling, denoising, reconstruction, etc. for digital images (e.g., frames of a video game or video file, still digital images, etc.). Although patch processing can be more efficient than processing full instances of input data in some cases, patch processing may not be efficiently applied to all arrangements of neural network, instances of input data, and/or output results. For example, in some embodiments, for using patch processing in processing digital images, although the output results can be relatively high resolution, the neural network should be small to medium in size.

In some embodiments, patch processing adds overlap regions around the patches for avoiding artifacts in the output results (e.g., when patch processing is used for upscaling digital images). In some of these embodiments, the overlap is called receptive field padding. The addition of the overlap adds to the computational effort involved in using patch processing. In other words, each patch is associated with an overlap region that overlaps neighboring patches' overlap regions and computations must be applied to the overlap region for each of the multiple patches that use each overlap region.

As described elsewhere herein, processing circuitry can select a tiling scheme from among multiple tiling schemes to be used for processing instances of input data in the neural network. The selection of a tiling scheme is generally made based on one or more tiling scheme rules. In some embodiments, the processing circuitry can select the patch processing when: (1) the neural network has less than Z layers, where Z=20 or another number; (2) the resolution or size of the output results are relatively high, such as full high definition, 2K, 4K, or another resolution; and (3) there is sufficient local memory for storing a specified amount (e.g., all, 80%, etc.) of data to be accessed while processing portions of instances of input data in the neural network. In some embodiments, for patch processing, filter sizes can vary in the neural network. In addition, in some embodiments where patch processing uses an overlap around the patches, sufficient compute resources should be available for processing the patches and the associated overlaps in the neural network. That is, the additional computational effort needed for processing the overlaps along with the patches should be taken into consideration when determining whether (or not) to use patch processing.

In some embodiments, for patch processing, the processing circuitry processes patches acquired from a given instance of input data in the neural network. In other words, the processing circuitry acquires the patches and possibly respective overlaps, i.e., the “portions” of the instances of input data, to be processed in the neural network. FIG. 6 presents a block diagram illustrating patches used in processing in accordance with some embodiments. Although an embodiment of patches is shown in FIG. 6, in some embodiments, different arrangements of instances of input data and/or patches are used. Generally, in the described embodiments, for using patch processing, patches are acquired from instances of input data, possibly combined with overlaps, and processed in the neural network to generate respective outputs, which are then combined into overall results for the instances of input data.

As can be seen in FIG. 6, an instance of input data 600 includes a number of pixels (or other subsections), three of which are labeled as pixel 602 (the remaining pixels are unlabeled for clarity). The pixels in instance of input data 600 are divided into a number of full patches and, where edges prevent full patches, partial patches. For example, patch 604 is a full patch, and thus includes a 4×5 section of pixels, and edge patch 606 is a partial, or “edge,” patch and includes only a 2×4 section of pixels. Each patch for the example in FIG. 6 includes an overlap 608, which is a shared region of pixels 2 pixels wide or high that is shared with the neighboring patch(es). Together, a patch and the respective overlap form a tile, which is shown as tile 610 and edge tile 612 for patch 604 and edge patch 606, respectively. Each full tile has a tile height of 8 pixels given the two 2-pixel overlaps and a tile width of 9 given the two 2-pixel overlaps. In addition, in some embodiments, an edge pad 614 is added to the external edges of instances of input data for processing in the neural network.

In some embodiments, among the operations for using the patch processing is determining the size and/or shape of the patches and possibly the size and/or shape of the overlaps. Generally, the sizes/shapes of the patches and/or the sizes/shapes of the overlaps are determined based on factors such as computational effort involved in processing the patches and their overlaps (i.e., the tiles) in the neural network, as well as avoiding artifacts in output results.

### Layer Processing Tiling Scheme

In some embodiments, a set of tiling schemes supported by processing circuitry in an electronic device includes a layer processing tiling scheme. Generally, for the layer processing tiling scheme, groups of channels or other divisions in instances of input data are combined, or “fused,” and processed as a group in convolutional or other layers of the neural network when being processed in the neural network. The layer processing tiling scheme is for neural networks (e.g., convolutional neural networks, encoder-decoder neural networks, etc.) used for processing digital images or other types of input data that can be divided into layers (and which may already be organized into a set of layers). Although layer processing can be more efficient than processing full instances of input data in some cases, layer processing may not be efficiently applied to all arrangements of neural network and/or instances of input data. For example, in some embodiments, for using layer processing for processing digital images, although channel sizes can be larger, feature sizes should generally be smaller.

As described elsewhere herein, processing circuitry can select a tiling scheme from among multiple tiling schemes to be used for processing instances of input data in the neural network. The selection of a tiling scheme is generally made based on one or more tiling scheme rules. In some embodiments, the processing circuitry can select the layer processing when: (1) the neural network has a relatively large number of layers, such as 30 or more layers; (2) the filters of the neural network are relatively small (e.g., 3×3, etc.); (3) the number of channels can be larger; and (3) there is sufficient local memory for storing a specified amount (e.g., all, 80%, etc.) of data to be accessed while processing portions of instances of input data in the neural network. In some embodiments, for layer processing, filter sizes can vary throughout the neural network (i.e., in different convolutional layers in the neural network).

In some embodiments, processing instances of input data using layer processing involves a number of steps in which two or more adjacent channels or other divisions in instances of input data are processed together. The channels are combined/fused and processed as a single unit within the neural network—e.g., in a convolutional layer of the neural network. FIG. 7 presents a block diagram illustrating layer processing in accordance with some embodiments. Although an embodiment of layer processing is shown in FIG. 7, in some embodiments, different arrangements of channels or other divisions in instances of input data are used. Generally, in the described embodiments, for using layer processing, sets or groups of channels or other divisions in instances of input data are acquired from instances of input data and/or intermediate data within the neural network and processed through the respective layers of the neural network to generate outputs for the respective layers. The outputs of the neural network generated using the fused channels or other divisions are then combined into overall results for the instances of input data.

As can be seen in FIG. 7, for a typical neural network, a number of channels are processed in convolutional layers N and N+1 (only a single channel, CH_0, is labeled in FIG. 7 in each convolutional layer for clarity). In the original case, shown at the top of FIG. 7, all channels are processed in a given convolutional layer and the output of that convolutional layer is stored in a remote memory (e.g., memory 308). Processing the channels in this way adds to bandwidth consumption and possibly contention on a fabric (e.g., communication fabric 310), which can slow the processing of the channels in the convolutional layers. In contrast, in some embodiments, for layer processing, groups or sets of channels are combined/fused in each layer and processed. The results of the processing of the combined/fused channels are sufficiently small (in terms of bytes required for storing the results) that the results can be stored in a local memory (e.g., memory 314 in node 302, etc.). In other words, layer passed processing can be considered a fused tile operation of two or more adjacent layers, which is shown as convolutional layer N and convolutional layer N+1 in FIG. 7.

The following pseudocode example identifies the operations of layer processing in accordance with some embodiments. Generally, the operations include starting processing a next layer (e.g., convolutional layer N+1) with partial outputs from a current layer (e.g., convolutional layer N). In this way, it is possible to store many, if not all, of the intermediate results of each convolutional layer in the local memory as described above. A tradeoff in some embodiments is the need for some redundant computations for of layer N. For the following example, oc is the output channel, is the input channel, n1 the number of output channels in layer N to tile and n2 the number output channels in layer N+1 to tile. In addition, comments are shown via the hash or pound sign #.

```
while oc[N+1] > 0: # next adjacent layer
  oc[N+1] −= n2
  while oc[N] > 0: # current layer
    oc[N] −= n1
    for j=0; j < n1; j++: # n1 is the number of output channels in layer N
    to tile
      for i=0; i < ic; i++:
        partial_out[j] += conv(feature[i], k[j])
      # write partial_out[j] to internal memory
    # Start processing with partial outputs in next layer
    for j = 0; j < n2; j++: # n2 is the number of output channels in layer
    N+1 to tile
      final_out[j] += conv(partial_out, k[j])
      #write final_out to internal or external memory
```

### Processes for Selecting and Using a Tiling Scheme

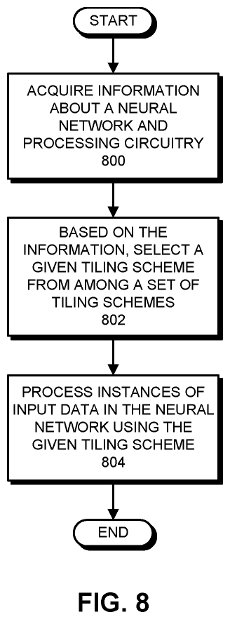

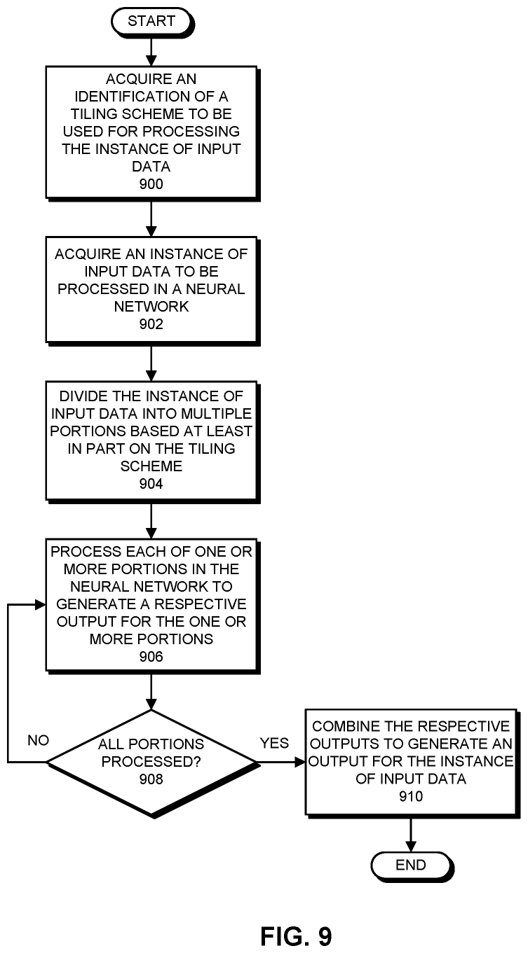

In the described embodiments, processing circuitry in an electronic device performs operations for selecting a tiling scheme and using the tiling scheme for processing instances of input data through a neural network. FIG. 8 presents a flowchart illustrating a process for selecting a tiling scheme in accordance with some embodiments. FIG. 9 presents a flowchart illustrating a process for using a tiling scheme for processing instances of input data through a neural network in accordance with some embodiments. FIGS. 8-9 are presented as general examples of operations performed in some embodiments. In other embodiments, however, different operations are performed and/or operations are performed in a different order. Additionally, although certain elements are used in describing the processes, in some embodiments, other elements perform the operations.

For the examples in FIGS. 8-9, processing circuitry is described as performing various operations. In some embodiments, at least some of the same processing circuitry performs the operations—but in other embodiments different portions of the processing circuitry perform each of the selecting and using operations. For example, assuming that the processing circuitry includes one or more CPUs and/or one or more GPUs, some or all of the CPUs and/or GPUs can perform operations for selecting the tiling scheme as shown in FIG. 8 and some or all of the CPUs and/or GPUs can perform operations for using the tiling scheme as shown in FIG. 9. For instance, in some embodiments, a CPU selects the tiling scheme and configures one or more GPUs to use the tiling scheme for processing instances of input data in the neural network. In addition, although the operations of FIGS. 8-9 are described as being performed by an electronic device, in some embodiments, two or more electronic devices perform some or all of the operations. For example, in some embodiments, a first electronic device performs the operations of FIG. 8 to select the tiling scheme to be used for processing instances of input data in the neural network (e.g., when the neural network is being trained or initially created, etc.) and one or more other electronic devices perform the operations of FIG. 9 for using the tiling scheme for processing instances of input data in the neural network.

For the examples in FIGS. 8-9, it is assumed that the neural network is a convolutional neural network that performs operations for upscaling digital images. In some embodiments, however, the neural network performs different operations and/or a different type of neural network is used for upscaling digital images. Generally, the described embodiments can select tiling schemes for various types of neural network and use the tiling schemes for processing instances of input data in the neural networks.

For the operations in FIGS. 8-9, it is assumed that a tiling scheme is used for processing instances of input data through a neural network. This is not always the case, however. In some embodiments, the processing circuitry can also choose not to use a tiling scheme. For example, in some cases, the overhead associated with using the tiling scheme (e.g., dividing data into portions, separately processing the portions, generating the combined output from the respective outputs for the portions, etc.) is sufficiently large that using a tiling scheme is not warranted—i.e., may not improve the performance of the processing circuitry when processing instances of input data in the neural network. In this case, the processing circuitry can simply process the whole instances of input data in the neural network—i.e., without using a tiling scheme to divide the instances of input data into portions before processing.

The process in FIG. 8 starts when processing circuitry in an electronic device (e.g., processor 312 in node 302) acquires information about a neural network and the processing circuitry (step 800). For this operation, the processing circuitry acquires information about the characteristics of the neural network and the properties of the processing circuitry that can be used for selecting a tiling scheme from among a set of tiling schemes to be used for processing instances of input data in the neural network. The processing circuitry can acquire the information from various sources, such as definition files for the neural network, configuration or other information files, outputs from software or hardware entities, user inputs, records created by the processing circuitry about the neural network and/or the processing circuitry at an earlier time, etc. In some embodiments, “acquiring” the information includes the processing circuitry newly generating at least some of the information, such as by processing definition files for the neural network to generate information about the arrangement of the neural network, requesting information about the properties of the processing circuitry from an operating system and/or another source, etc.

In some embodiments, the information about the characteristics of the neural network includes information about an arrangement or configuration of the neural network such as a number of layers, a number nodes or other elements (e.g., convolutional elements, addition or RELU elements, etc.) in each or all of the layers, a nature of each of the layers, relationships between the layers, a connectivity of elements or layers, inputs to or outputs from the layers, etc. As another example, the information about the characteristics of the neural network includes information about properties of operations performed within the neural network, such as properties of filters used in the neural network; changes to data within the neural network (e.g., downsampling, pooling, etc.), types of computations, etc. As yet another example, in some embodiments, the information about the characteristics of the neural network includes information about feature sizes, channel sizes, etc. As yet another example, in some embodiments, the information about the neural network includes properties of instances of input data to be processed in the neural network (e.g., sizes, types or arrangement of data, etc.) and properties of outputs of the neural network (e.g., sizes, types or arrangement of data, etc.).

In some embodiments, the information about the properties of the processing circuitry includes information about a processing capacity or bandwidth of the processing circuitry. For instance, in some embodiments, the information includes an identification of a number, type, and/or arrangement of GPU cores, CPU cores, compute units, and/or other processing circuitry. In some embodiments, the information about the properties of the processing circuitry includes information about a bandwidth capacity of a memory bus and/or system bus. In some embodiments, the information about the properties of the processing circuitry includes information about limits of processing circuitry (e.g., heat thresholds, etc.), etc. In some embodiments, the information about the properties of the processing circuitry includes information about an amount of local memory available for storing data by the processing circuitry and/or an amount of remote memory.

Returning to FIG. 8, the processing circuitry then, based on the information, selects a given tiling scheme from among a set of tiling schemes (step 802). For this operation, the processing circuitry uses tiling scheme selection rules (e.g., tiling scheme selection rules 406) and the information to select the tiling scheme. For example, in some embodiments, the tiling scheme selection rules are arranged in a table or other record in which combinations of characteristics of the neural network and/or properties of the processing circuitry are associated with tiling schemes from among the set of tiling schemes. In these embodiments, the processing circuitry performs a lookup in the table or other record to acquire an identifier for a particular tiling scheme from among the set of tiling schemes based on the information or values computed or determined therefrom.

In some embodiments, as part of step 802, the processing circuitry determines one or more additional values or inputs to be used for the tiling scheme. For example, assuming that the patch processing tiling scheme is to be used, the processing circuitry can determine a size and/or shape for the patches. In other words, the processing circuitry can determine which portion of instances of input data are to be included in patches—so that the instances of input data are separated into a mosaic, grid, or other arrangement of patches. As another example, and again assuming that the patch processing tiling scheme is to be used (and recalling that image upscaling is the operation performed by the neural network), the processing circuitry can determine an overlap to be added to the patches to avoid the introduction/creation of artifacts in the output image that can occur with patch processing. Generally, in these embodiments, the processing circuitry, when selecting a tiling scheme, determines other values or inputs to be used for the tiling scheme when processing instances of input data in the neural network.

The processing circuitry then processes instances of input data in the neural network using the given tiling scheme (and possibly the other values/inputs) (step 804). As described below in more detail for FIG. 9, this operation includes the processing circuitry dividing the instances of input data into portions in accordance with the tiling scheme and processing the instances of input data in the neural network.

The process in FIG. 9 starts when processing circuitry in an electronic device, having already selected a tiling scheme to be used (e.g., as described for FIG. 8), acquires an identification of a tiling scheme to be used for processing instances of input data in the neural network (step 900). For this operation, the processing circuitry acquires the output/result of the operations for selecting the tiling scheme, such as a numerical or other identifier for the tiling scheme to be used. For example, the processing circuitry, when selecting the tiling scheme, may update a register or memory location with an identifier for the given tiling scheme, which is subsequently read prior to commencing processing instances of input data in the neural network using the given tiling scheme. For the example in FIG. 9, it is assumed that line buffer processing is the tiling scheme that is used for processing the instance of input data/digital image in the neural network.

The processing circuitry then acquires an instance of input data to be processed in the neural network (step 902). For this operation, the processing circuitry acquires, from a local memory or a remote memory, the instance of input data. For example, the processing circuitry may receive a list or table of instances of input data to be processed and acquire a next instance of input data from the list or table. As described above, the instance of input data is assumed to be a lower resolution digital image that is to be upscaled to a higher resolution.

The processing circuitry next divides the instance of input data into multiple portions based at least in part on the tiling scheme (step 904). For this operation, the processing circuitry separates the instance of input data into an arrangement of portions in accordance with the portions of the tiling scheme. Continuing the digital image upscaling example, the processing circuitry divides the instance of input data into a number of lines of one or more pixels in height and of the width of the digital image. In some embodiments, the processing circuitry uses one or more values or inputs—other than the simple arrangement of portions indicated by the tiling scheme—for determining the portions. For example, in some embodiments, the processing circuitry uses the above described overlap for determining the portions and/or determining an arrangement of the portions.

The processing circuitry then processes each of one or more portions in the neural network to generate a respective output for the one or more portions (step 906). For this operation, the processing circuitry processes a number of portions associated with the particular iteration of the processing of the portions and/or other factors to generate the respective result. For example, in some embodiments, the processing circuitry processes multiple lines of a digital image together to generate a single result/output line (e.g., as shown in the first pass and/or subsequent passes of FIG. 5). The processing circuitry then determines whether (or not) all of the portions of the instance of input data have been processed (step 906). If not, the processing circuitry returns to step 906 to process next portion(s) of the instance of input data in the neural network.

When all of the portions of the instance of input data have been processed in the neural network (step 908), the processing circuitry combines the respective outputs from the portions to generate an output from the neural network for the instance of input data (step 910). For this operation, the processing circuitry joins together all of the respective outputs to form the output from the neural network for the instance of input data. For example, and continuing the line buffer processing example, the processing circuitry can combine the upscaled lines generated in step 906 for the portion(s) of the instance of input data to form an upscaled digital image, which is the output from the neural network.

In some embodiments, at least one electronic device (e.g., electronic device 300, etc.) or some portion thereof uses code and/or data stored on a non-transitory computer-readable storage medium to perform some or all of the operations described herein. More specifically, the at least one electronic device reads code and/or data from the computer-readable storage medium and executes the code and/or uses the data when performing the described operations. A computer-readable storage medium can be any device, medium, or combination thereof that stores code and/or data for use by an electronic device. For example, the computer-readable storage medium can include, but is not limited to, volatile and/or non-volatile memory, including flash memory, random access memory (e.g., DDRS DRAM, SRAM, eDRAM, etc.), non-volatile RAM (e.g., phase change memory, ferroelectric random access memory, spin-transfer torque random access memory, magnetoresistive random access memory, etc.), read-only memory (ROM), and/or magnetic or optical storage mediums (e.g., disk drives, magnetic tape, CDs, DVDs, etc.).

In some embodiments, one or more hardware modules perform the operations described herein. For example, the hardware modules can include, but are not limited to, one or more central processing units (CPUs)/CPU cores, graphics processing units (GPUs)/GPU cores, application-specific integrated circuit (ASIC) chips, field-programmable gate arrays (FPGAs), compressors or encoders, encryption functional blocks, compute units, embedded processors, accelerated processing units (APUs), controllers, network communication links, and/or other functional blocks. When circuitry (e.g., integrated circuit elements, discrete circuit elements, etc.) in such hardware modules is activated, the circuitry performs some or all of the operations. In some embodiments, the hardware modules include general purpose circuitry such as execution pipelines, compute or processing units, etc. that, upon executing instructions (e.g., program code, firmware, etc.), performs the operations. In some embodiments, the hardware modules include purpose-specific or dedicated circuitry that performs the operations “in hardware” and without executing instructions.

In some embodiments, a data structure representative of some or all of the functional blocks and circuit elements described herein (e.g., electronic device 300 or some portion thereof) is stored on a non-transitory computer-readable storage medium that includes a database or other data structure which can be read by an electronic device and used, directly or indirectly, to fabricate hardware including the functional blocks and circuit elements. For example, the data structure may be a behavioral-level description or register-transfer level (RTL) description of the hardware functionality in a high-level design language (HDL) such as Verilog or VHDL. The description may be read by a synthesis tool which may synthesize the description to produce a netlist including a list of transistors/circuit elements from a synthesis library that represent the functionality of the hardware including the above-described functional blocks and circuit elements. The netlist may then be placed and routed to produce a data set describing geometric shapes to be applied to masks. The masks may then be used in various semiconductor fabrication steps to produce a semiconductor circuit or circuits (e.g., integrated circuits) corresponding to the above-described functional blocks and circuit elements. Alternatively, the database on the computer accessible storage medium may be the netlist (with or without the synthesis library) or the data set, as desired, or Graphic Data System (GDS) II data.

In this description, variables or unspecified values (i.e., general descriptions of values without particular instances of the values) are represented by letters such as N, T, and X. As used herein, despite possibly using similar letters in different locations in this description, the variables and unspecified values in each case are not necessarily the same, i.e., there may be different variable amounts and values intended for some or all of the general variables and unspecified values. In other words, particular instances of N and any other letters used to represent variables and unspecified values in this description are not necessarily related to one another.

The expression “et cetera” or “etc.” as used herein is intended to present an and/or case, i.e., the equivalent of “at least one of” the elements in a list with which the etc. is associated. For example, in the statement “the electronic device performs a first operation, a second operation, etc.,” the electronic device performs at least one of the first operation, the second operation, and other operations. In addition, the elements in a list associated with an etc. are merely examples from among a set of examples—and at least some of the examples may not appear in some embodiments, despite appearing in the list.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. An electronic device, comprising:
processing circuitry configured to:
acquire information about a neural network and properties of the processing circuitry;
select a given tiling scheme from among a set of tiling schemes based on the information; and
process instances of input data in the neural network using the given tiling scheme.

2. The electronic device of claim 1, wherein each tiling scheme of the set of tiling schemes is associated with a different arrangement of portions into which instances of input data are divided for processing in the neural network.

3. The electronic device of claim 2, wherein, when processing the instances of input data using the given tiling scheme, the processing circuitry configured to:
for each instance of input data:
divide the instance of input data into a plurality of portions based at least in part on the arrangement of portions associated with the given tiling scheme;
process each of one or more portions to generate a respective output for the one or more portions; and
combine the respective outputs to generate an output for the instance of input data.

4. The electronic device of claim 1, wherein the set of tiling schemes includes two or more of:
a line buffer processing tiling scheme;
a patch processing tiling scheme; and
a layer processing tiling scheme.

5. The electronic device of claim 4, wherein, for the line buffer processing tiling scheme:
the portions of the instances of input data are lines from among a plurality of lines in the instances of input data; and
line buffer processing is used for processing sets of one or more lines from the instances of input data.

6. The electronic device of claim 4, wherein, for the patch processing tiling scheme:
the portions of the instances of input data are patches from among a plurality of patches in the instances of input data; and
patch processing is used for processing patches from the instances of input data.

7. The electronic device of claim 6, using the patch processing tiling scheme includes determining one or more of:
a size and/or shape of the patches; and
an overlap of each patch with neighboring patches.

8. The electronic device of claim 4, wherein, for the layer processing tiling scheme:
the portions of the instances of input data are channels or other subdivisions from among a plurality of channels in the instances of input data; and
layer processing is used for processing groups of two or more channels or other subdivisions of the instances of input data.

9. The electronic device of claim 1, wherein the information about the neural network includes information about one or more of:
an internal arrangement of the neural network;
properties of filters used in the neural network;
feature sizes for the neural network; and
channel sizes for the neural network.

10. The electronic device of claim 1, wherein the information about the neural network includes information about one or more of:
properties of instances of input data to be processed in the neural network; and
properties of outputs of the neural network.

11. The electronic device of claim 1, wherein the information about the properties of the processing circuitry includes information about one or more of:
an amount of local memory available for storing data by the processing circuitry; and
a processing capacity of the processing circuitry.

12. The electronic device of claim 1, wherein:
the processing circuitry includes one or more processors; and
one or more of the processors performs the acquiring and the selecting and one or more of the processors performs the processing.

13. A method for processing instances of input data in a neural network, the method comprising:
acquiring information about a neural network and properties of processing circuitry;
selecting a given tiling scheme from among a set of tiling schemes based on the information; and
processing instances of input data in the neural network using the given tiling scheme.

14. The method of claim 13, wherein each tiling scheme of the set of tiling schemes is associated with a different arrangement of portions into which instances of input data are divided for processing in the neural network.

15. The method of claim 14, wherein processing the instances of input data using the given tiling scheme includes:
for each instance of input data:
dividing the instance of input data into a plurality of portions based at least in part on the arrangement of portions associated with the given tiling scheme;
processing each of one or more portions to generate a respective output for the one or more portions; and
combining the respective outputs to generate an output for the instance of input data.

16. The method of claim 13, wherein the set of tiling schemes includes two or more of:
a line buffer processing tiling scheme;
a patch processing tiling scheme; and
a layer processing tiling scheme.

17. The method of claim 16, wherein, for the line buffer tiling scheme:
the portions of the instances of input data are lines from among a plurality of lines in the instances of input data; and
line buffer processing is used for processing sets of one or more lines from the instances of input data.

18. The method of claim 17, wherein, for the patch processing tiling scheme:
the portions of the instances of input data are patches from among a plurality of patches in the instances of input data; and
patch processing is used for processing patches from the instances of input data.

19. The method of claim 16, using the patch processing tiling scheme includes determining one or more of:
a size and/or shape of the patches; and
an overlap of each patch with neighboring patches.

20. The method of claim 16, wherein, for the layer processing tiling scheme:
the portions of the instances of input data are channels or other subdivisions from among a plurality of channels in the instances of input data; and
layer processing is used for processing groups of two or more channels or other subdivisions of the instances of input data.

21. The method of claim 13, wherein the information about the neural network includes information about one or more of:
an internal arrangement of the neural network;
properties of filters used in the neural network;
feature sizes for the neural network; and
channel sizes for the neural network.

22. The method of claim 13, wherein the information about the neural network includes information about one or more of:
properties of instances of input data to be processed in the neural network; and
properties of outputs of the neural network.

23. The method of claim 13, wherein the information about the properties of the processing circuitry includes information about one or more of:
an amount of local memory available for storing data by the processing circuitry; and
a processing capacity of the processing circuitry.
